(19) United States
(12) Patent Application Publication
(10) Pub. No.: US 2007/0154869 A1
(43) Pub. Date: Jul. 5, 2007

(54) Method of making dental implant plate

(75) Inventors: Hong-Tzong Yau, Chiayi County (TW); Chuan-Chu Kuo, Chiayi County (TW); Jiun-Ren Chen, Yunlin County (TW); Chine-An Chen, Kaohsiung County (TW); Fu-Chieh Hsiao, Chiayi City (TW); Lee-Sen Tsou, Hsinchu City (TW)

Correspondence Address: BACON & THOMAS, PLLC, 625 SLATERS LANE, FOURTH FLOOR, ALEXANDRIA, VA, 22314, US

(73) Assignee: PUO YUEN TECHNOLOGY CO., LTD,, CHANG HWA HSIEN (TW)

(21) Appl. No.: 11/495,720

(22) Filed: Jul. 31, 2006

(30) Foreign Application Priority Data
Dec. 29, 2005 (TW) 94147343

(51) Int. Cl. A61C 5/00

(52) U.S. Cl. 433/215

(57) ABSTRACT

A method of making dental plate implant includes the steps of preparing an oral scanning image generated from a tomogram of a patient's mouth; producing and scanning a substantial model from a rollover of the patient's mouth to prepare an oral model; positioning the oral model to the oral scanning image by comparing a positioning object (defined by the oral model) and a referential object (defined by the oral scanning image) respectively; conducting a multi-stage amplification calculation of the oral model to further generate a digital processing model; and processing the digital processing model through a machine tool to produce a dental plate implant.

### BACKGROUND OF THE INVENTION

1. Field of the Invention

The present invention relates generally to the art of dental implantation, and more particularly, to a method of making a dental plate implant.

2. Description of the Related Art

Before a conventional dental implantation is operated, the dentist usually conducts a presurgical arrangement by reference to the patient's tomogram and the relevant medical records. Through such information and the dentist's expertise, the dentist can simulate a 3D model from the 2D tomogram in his/her mind and then conclude the position and the depth that an implant will be implanted and how the interference between the implant and the nerves and the antra. Because the tomogram is 2D after data processing, making a conclusion needs a certain degree of professional experiences and expertise, and thus it is difficult to make a precisely accurate conclusion.

In addition, the dentist has to use a special tool or apparatus to drill a hole in the patient's alveolar bone and then to implant the implant. The position, depth, and strength for the drilling have to depend on the dentist's professional experiences, such that there is a certain degree of risk for such surgery.

As indicated above, only the dentist who has been trained professionally and owned a great number of experiences can ensure the safety and accuracy of the dental implantation.

### SUMMARY OF THE INVENTION

The primary objective of the present invention is to provide a method of making a dental plate implant, which enhances the accuracy and safety of dental implantation.

The secondary objective of the present invention is to provide a method of making a dental plate implant, which provides the patient with a tailor-made dental plate implant to make the dental implantation more accurate and to reduce the surgical risk.

The foregoing objectives of the present invention are attained by the method including the steps of preparing an oral scanning image generated from a tomogram of a patient's mouth; producing and scanning a substantial model from a rollover of the patient's mouth to prepare an oral model; positioning the oral model to the oral scanning image by positioning at least two corresponding features obtained from a positioning object (defined by the oral model) and a referential object (defined by the oral scanning image) respectively; conducting a multi-stage amplification calculation of the oral model to get a magnitude of distance extending outward, further generating a digital model, and then routing a processing path through computer-aided manufacture (CAM) to build a digital processing model; and processing the digital processing model through a machine tool to produce a dental plate implant.

### BRIEF DESCRIPTION OF THE DRAWINGS

FIG. 1 is a brief block diagram of a preferred embodiment of the present invention, showing brief primary steps.

FIG. 2 is a detailed block diagram view of the preferred embodiment of the present invention, showing detailed primary steps.

FIG. 3 illustrates the oral scanning image indicated in the first step of the preferred embodiment of the present invention.

FIG. 4 illustrates the oral model indicated in the second step of the preferred embodiment of the present invention.

FIG. 5 illustrates that the oral mode is positioned to the oral scanning image as indicated in the third step of the preferred embodiment of the present invention.

FIG. 6 illustrates the multi-stage amplified status indicated in the fourth step of the preferred embodiment of the present invention.

FIG. 7 illustrates that a specific multi-stage amplified section is taken for the dental plate implant as indicated in the fifth step of the preferred embodiment of the present invention.

### DETAILED DESCRIPTION OF PREFERRED EMBODIMENTS

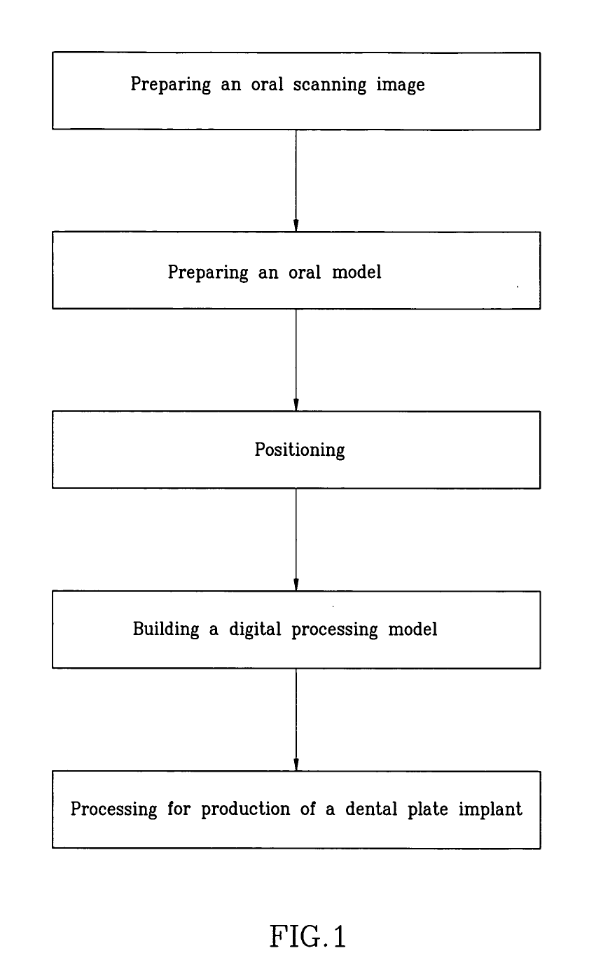

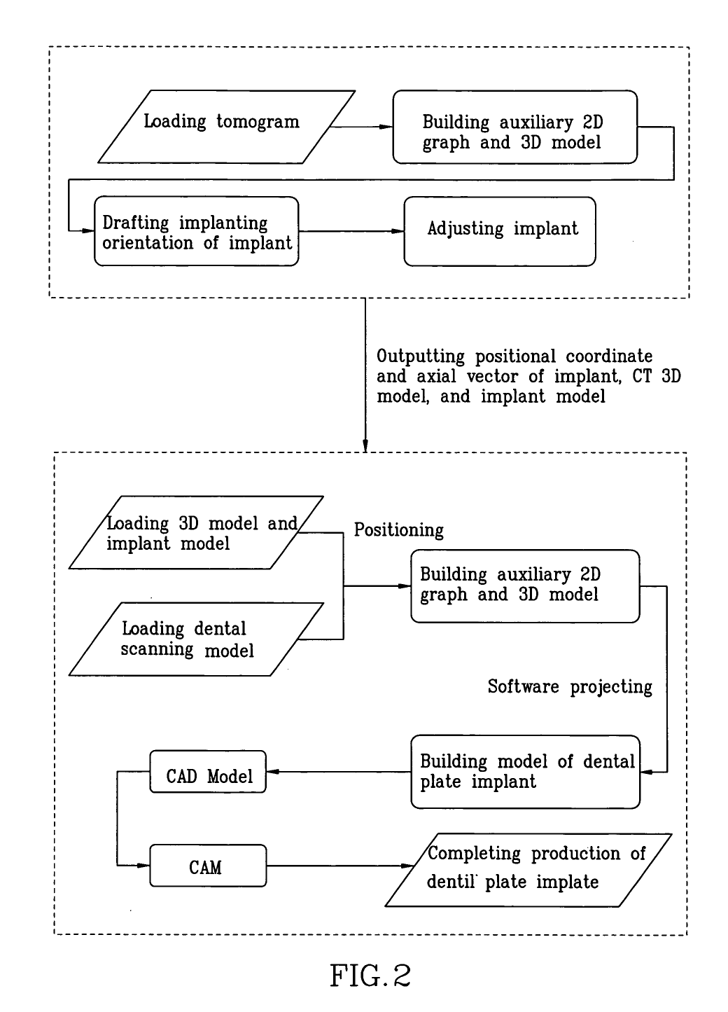

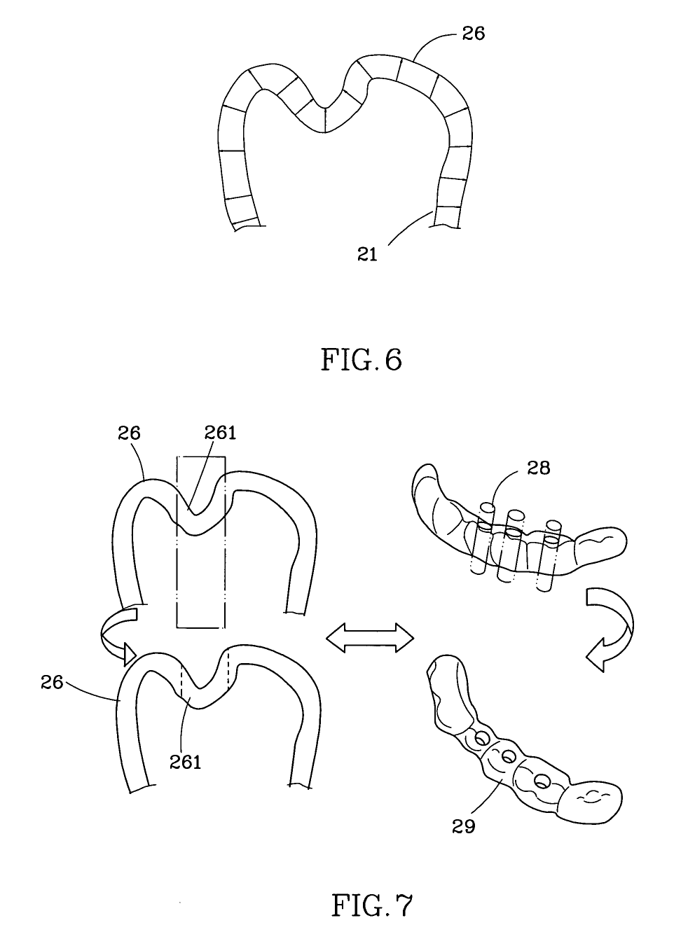

Referring to FIGS. 1-7, a method of making a dental plate implant according to a preferred embodiment of the present invention includes the following steps.

(a) Preparing an Oral Scanning Image

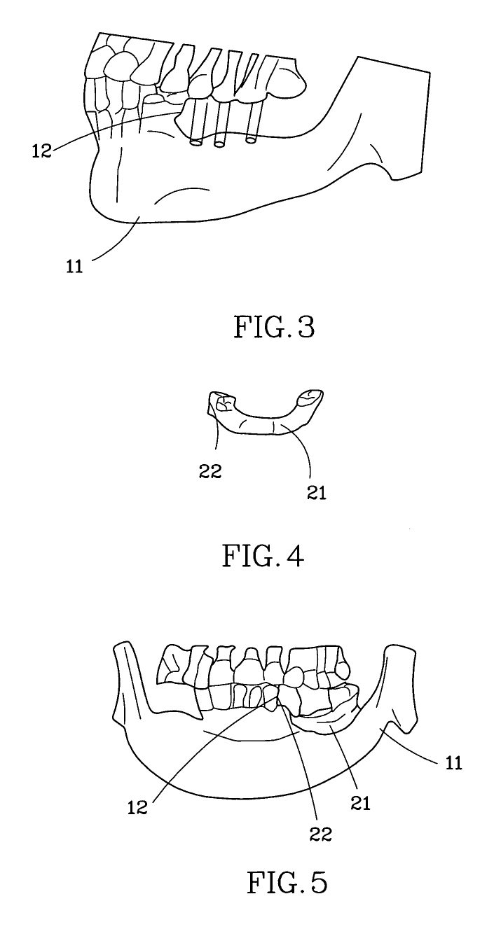

Prepare an oral scanning image 11, as shown in FIG. 3 from a tomogram taken from a patient's mouth and then display oral scanning image 11 on a screen. Draw a curve of dental arch along the profile of the alveolar bone on the image 11 and then slice along a normal line and a tangent of the curve to generate an auxiliary sectional diagram of the dental jaw to build a 2D graph and a 3D model. Draft an implanting orientation of an implant according to the oral scanning image 11 without interference with human nerves or antra and then adjust the implant to enable it to be properly located. Convert the oral scanning image 11 into an electronic file for output and then output the positional coordinate and the axial vector of the implant, a computed tomography (CT) 3D model, and an implant model for the basis of the following processing dental plate implant.

(b) Preparing an Oral Model

Load the aforementioned CT 3D model and the implant model, produce a substantial model from a rollover of a patient's mouth, and scan the substantial model to prepare (load) an oral model 21, as shown in FIG. 4.

(c) Positioning

Define the oral scanning image 11 as a referential object and define the oral model 21 as a positioning object. Pick at least two corresponding features 12 and 22 (e.g. one tooth or one portion of the alveolar bone) from the referential object 11 and the positioning object 21 respectively, for positioning of the features 12 and 22 to enable the oral model 21 to be positioned to the oral scanning image 11, as shown in FIG. 5, to build a 2D graph and a 3D model.

(d) Building a Digital Processing Model

Conduct a multi-stage amplification calculation of the oral model 21 through software projecting, get a magnitude of distance extending outward to further generate a digital model 26, i.e. the model of the dental, conduct an integration (e.g. Boolean operation) of the digital model 26 and an implant 28 being implanted to get a corresponding relationship between the implant 28 and the digital model 26, then capture a computer-aided design (CAD) model of a required plate implant section 261, and finally route a processing path through CAM to generate a digital processing model of the plate implant section 261.

(e) Processing for Production of a Dental Plate Implant

Process the digital processing model through a machine tool to produce a dental plate implant 29.

After the steps indicated above, a tailor-made dental plate implant for the patient can be easily produced and the dentist can do relevant dental implantation based on the dental plate implant.

In conclusion, the present invention includes the following advantages.

1. Enhancement of Accuracy and Safety of Dental Implantation

The present invention employs the computerized manufacturing processes, the comparison between the tomographic data and the substantial dental model, and the multi-stage amplification to produce the much accurate dental plate implant, thus greatly enhancing the accuracy and safety.

2. Reduction of Surgical Risk

Based on the present invention, a tailor-made dental plate implant for the patient can be produced and the dentist can do the dental implant surgery with much trust on the dental plate implant. In other words, the present invention can effectively lower the technical threshold for the dentist's execution of the surgery and reduce the surgical risk.

Although the present invention has been described with respect to a specific preferred embodiment thereof, it is no way limited to the details of the illustrated structures but changes and modifications may be made within the scope of the appended claims.

What is claimed is:

1. A method of making a dental plate implant, comprising steps of:
(a) preparing an oral scanning image generated from a tomogram of a patient's mouth;
(b) producing and scanning a substantial model from a rollover of the patient's mouth to prepare an oral model;
(c) picking and positioning at least two corresponding features from said oral model as a positioning object and said oral scanning image as a referential object respectively to position said oral model relatively to said oral scanning image;
(d) conducting a multi-stage amplification calculation of said oral model to get a magnitude of distance extending outward, further generating a digital model, and then routing a processing path through computer-aided manufacture (CAM) to build a digital processing model; and
(e) processing said digital processing model through a machine tool to produce a dental plate implant.

2. The method as defined in claim 1, wherein the step (a) further includes an operation of drafting an implanting orientation of an implant according to said oral scanning image and then adjusting said implant to enable said implant to be properly located.

3. The method as defined in claim 2 wherein in the step (a), while drafting the implanting orientation of said implant, the patient's nerves and antra are avoided.

4. The method as defined in claim 1, wherein the step (a) further including an operation of converting said oral scanning image into an electronic file for output and outputting a coordinate and an axial vector that said implant is located.

5. The method as defined in claim 1, wherein the step (d) further includes an operation of integrating said digital model and said implant to get a corresponding relationship between said implant and said digital model and then routing a processing path through CAM to generate a digital processing model.
